(19) United States
(12) Patent Application Publication
(10) Pub. No.: US 2016/0183332 A1
(43) Pub. Date: Jun. 23, 2016

(54) MICROWAVE GENERATOR AND MICROWAVE OVEN

(71) Applicant: E.G.O. Elektro-Geraetebau GmbH, Oberderdingen (DE)

(72) Inventors: Marcus Frank, Oberderdingen (DE); Martin Baier, Ettlingen (DE); Roman Riffel, Karlsdorf (DE)

(21) Appl. No.: 14/971,526

(22) Filed: Dec. 16, 2015

(30) Foreign Application Priority Data
Dec. 17, 2014 (DE) 10 2014 226 280.1

(51) Int. Cl. H05B 6/68; H05B 6/72; H05B 6/70; H05B 6/64

(52) U.S. Cl. CPC H05B 6/686; H05B 6/642; H05B 6/72; H05B 6/705

(57) ABSTRACT

The invention relates to a microwave generator in which the total maximum available microwave power is divided between at least two channels, preferably two identical channels. A higher degree of efficiency can be achieved in this way. The invention further relates to a microwave oven having a microwave generator of this kind.

### CROSS-REFERENCE TO RELATED APPLICATIONS

This application claims priority to German Application No. 10 2014 226 280.1, filed Dec. 17, 2014, the contents of which are hereby incorporated herein in its entirety by reference.

### TECHNOLOGICAL FIELD

The present invention relates to a microwave generator for a microwave oven, and to a microwave oven having a microwave generator of this kind.

### BACKGROUND

A microwave generator is currently typically based on a magnetron in order to generate microwaves. However, this has the disadvantage that it can only emit waves with a defined wavelength. Therefore, standing waves which are always at their maximum at the same points can be produced in the cooking area or in the cavity of a microwave oven. Therefore, hot and cold regions can be created in the product being cooked, this potentially resulting in the product being overcooked in the first instance and remaining cold in the second instance. Furthermore, the power of a microwave generator with a magnetron cannot be continuously adjusted. It is only possible to adjust the power by varying the duty cycle in an intermittent operating mode. The process of adjusting the power can be improved, for example, by activating the magnetron with an inverter instead of with a high voltage source. However, it is not possible to vary the wavelength in this case either.

A further development of a magnetron-based microwave generator are semiconductor microwave generators in which microwaves are generated by means of an electronics system with power transistors. A microwave generator of this kind is known from WO 2013/063985 A1 for example. Both frequency and power can be varied with the microwave generator. The input of heat into the product being cooked can be prespecified in this way and the distribution of heat is improved. In addition, the advantage of it being possible to measure the power which is introduced into the product being cooked is achieved in comparison to magnetrons.

Semiconductor-based microwave generators are known in principle nowadays, but there has been a lack of end-user consumer devices to date. One reason for this is, in particular, that the production costs have been too high to date.

### BRIEF SUMMARY

One problem of the invention, therefore, is to provide a microwave generator which is improved, in particular is more expedient in respect of production costs thereof, in comparison to microwave generators known from the prior art. A further problem of the invention is to provide a microwave oven having a microwave generator of this kind.

The problems are solved by a microwave generator and by a microwave oven having the features of the claims. Advantageous and preferred refinements of the invention are the subject matter of the further claims and will be explained in greater detail in the text which follows. In the process, some of the features will be described only for the microwave generator or only for the microwave oven. However, irrespective of this, the features are intended to be able to independently apply both for the microwave generator and also for the microwave oven. The wording of the claims is incorporated in the content of the description by express reference.

The microwave generator has at least one first channel and one second channel, under certain circumstances even three channels or even more. The first channel has a first amplifier circuit and a first antenna, which is connected to the first amplifier circuit, for generating microwaves with a power of up to a maximum of a first partial power. The second channel has a second amplifier circuit and a second antenna, which is connected to the second amplifier circuit, for generating microwaves with a power of up to a maximum of a second partial power. A maximum total power of the microwave generator is made up of the sum of the partial powers of the channels of the microwave generator.

The refinement according to the invention with the division into at least two or more channels means that each channel has to provide only a portion of the microwave power which is to be output in total. For example, when the individual channels are of physically identical design, each channel can provide half of the power which is to be output in total. This reduces the respective power loss and therefore increases the energy efficiency. Complexity in respect of design is also reduced in comparison to a single channel with a correspondingly higher power as a result. In spite of this, the channels can resort to the same peripheral, for example control system and/or cooling system. Furthermore, the two channels can be operated at different frequencies, as a result of which the number of modes in a cavity of a microwave oven can be increased. The phase positions of the channels relative to one another can also be varied, in particular during operation of the two channels at the same frequency. The uniformity of the distribution of heat can be improved in this way.

The microwave generator according to the invention is suitable, in particular, for built-in combination appliances and, respectively, the microwave oven can also be designed as a combination appliance, that is to say can also have the functionality of a simple oven. An appliance of this kind can look like a normal European oven from the outside. However, in addition to the conventional resistance heating systems, said device additionally has a microwave heating system which is provided by the microwave generator.

In this document, a channel can be understood to mean, in principle, a unit which serves to independently generate and emit microwaves. To this end, further components, for example a respective oscillator, can also be provided in addition to the amplifier circuits and antennas already described. However, these components can, in principle, also be shared by several channels.

According to one embodiment, the microwave generator has a number of further channels, with each further channel having a respective amplifier circuit and a respective antenna, which is connected to the respective amplifier circuit, for generating microwaves with a power of up to a maximum of a respective partial power. In this way, the total power can be divided between even more channels, it being possible for this to increase the energy efficiency even further.

According to a further embodiment, some channels, preferably all of the channels, are physically identical to one another. This can simplify production and control. The amplifier circuits each preferably have a number of transistors, in particular power transistors, for generating or amplifying a current which operates the respective antenna. Therefore, it is possible to resort to semiconductor technology for the amplifier circuits. In particular, transistors of this kind may be LDMOS (Laterally Diffused Metal Oxide Semiconductor) transistors which have proven advantageous for typical intended applications. The respective amplifier circuit can be of two-stage design in particular. This has also proven expedient.

Each channel advantageously has a respective power measuring circuit for measuring a power which is output by the channel. This allows the respective output power to be monitored. In particular, a circulator can be connected to the power measuring circuit, the respective antenna and a respective further power measuring circuit for measuring a reflected power further being connected to the circulator. This allows both the output power and also the reflected power to be measured. The power which is actually output into the product being cooked can be identified in this way. Therefore, in particular, a control loop can be constructed, for example in order to introduce a specific desired or prespecified power into the product being cooked.

The amplifier circuits can advantageously be arranged on a common amplifier board. This allows a simple design, in particular also simplified and, respectively, improved cooling. An amplifier board is preferably mounted, without intermediate means, on a heat sink of the microwave generator, preferably on a flat bottom face of the heat sink. This has proven advantageous for the purpose of heat dissipation. This also increases the energy efficiency on account of improved cooling of the components, in particular of power transistors.

According to a preferred embodiment, a fan is associated with the heat sink, electrical power further preferably being supplied to said fan by a control board which is connected to the amplifier board. The fan can, in particular, blow air along the heat sink and/or through the heat sink, in order to thereby discharge heat more effectively.

A control board, further boards, the antennas, fans and/or further components can advantageously be mounted on the heat sink. Therefore, the components can likewise be advantageously cooled. In this case, boards and/or antennas are preferably screwed directly to the heat sink. Therefore, the heat sink can form a holding device at the same time. Fastening geometries for other components can also be integrated into the heat sink. This simplifies assembly and reduces costs. The heat sink is preferably composed of aluminum and is further preferably produced as an extruded profile. A fan is preferably fastened to the heat sink by means of a respective holder, preferably a holder which is composed of plastic.

The antennas are preferably fitted, without intermediate means, to one end of the heat sink. In particular, the antennas are fitted directly or without a flange plate or the like to the heat sink. The antennas are further preferably directly wired to the respective amplifier circuits. This can mean, in particular, that the antennas are connected without the interconnection of coaxial plugs and/or coaxial cables. In comparison to known embodiments with coaxial connecting pieces with which microwaves are routed out of a housing and routed to the antennas by means of coaxial lines, this reduces complexity in respect of design and therefore also reduces costs. A power measuring circuit can be arranged between the amplifier circuit and the antenna, it being possible in this case for the antenna to be wired directly to the power measuring circuit. In the present case, this arrangement should be understood to mean direct wiring of the antenna to the power measuring circuit. In particular, a respective antenna can be connected through a respective hole in the heat sink.

The microwave generator is preferably designed for the purpose of operating the channels at different frequencies and/or with different phases. Therefore, the number of modes in a cavity into which the microwaves are emitted can be increased in order to heat a product being cooked therein more uniformly.

The antennas can advantageously together form a phased array antenna, with the microwave generator preferably being designed for the purpose of setting a propagation direction of microwaves, which are emitted by the phased array antenna, by means of phase relationships of the channels with respect to one another. Here, a phased array antenna is an arrangement of several antennas next to one another. In this case, the antennas typically have a respective fixed distance between their input coupling points into the cavity. Waves with an identical frequency form a resulting wave by interference. In this case, the propagation direction can typically be adjusted by means of the phase relationship of the waves with respect to one another. The mode pattern in the cavity can be adjusted by the use of a phased array antenna of this kind, for example such that a product being cooked can be acted on in a targeted manner. This is possible, in principle, with two channels and more. However, more than two channels can also be used. Despite increased complexity, the advantage of the channels being able to at least partially resort to the same peripheral is maintained in this case.

According to a preferred embodiment, the microwave generator further has a cover which closes off the microwave generator such that it is impermeable to microwaves at least on one side, preferably at the bottom. The cover is preferably composed of aluminum, for example diecast aluminum, it also being possible to use other electrically conductive and therefore shielding metals, alloys or mixtures, for example mixtures of plastics or ceramics with conductive fillers. The cover further preferably forms, together with the heat sink, a housing of the microwave generator. The described embodiments have proven advantageous particularly in respect of the impermeability to microwaves. A compact design, which is therefore easy to handle, is also achieved. Microwave sealing means which ensure an electrical connection between the housing parts which is suitable for high frequencies may possibly be used between the cover and the heat sink.

The invention further relates to a microwave oven which has a cavity and a microwave generator according to the invention. The microwave generator is designed for the purpose of emitting microwaves into the cavity. The advantages of a microwave generator according to the invention for a microwave oven described further above can be achieved by means of the microwave oven according to the invention. In this case, it is possible to resort to all of the described embodiments and variants in respect of the microwave generator. Explained advantages accordingly apply.

A cavity is intended to be understood to mean, in particular, an enclosed chamber into which a product to be cooked or another object to be heated can be inserted. A cavity of this kind is typically enclosed such that it is impermeable to microwaves, in order to prevent a user from being put at risk.

The microwave oven may be, in particular, a combination appliance which can be a heating system combination comprising microwaves and conventional resistance heating. The resistance heating system may be designed, for example, as in a conventional oven, steam cooker or grill. The appliance can be designed, in particular, as a built-in appliance.

The cavity preferably has a number of waveguides, with one of the antennas being accommodated in each waveguide. This allows the microwaves to be coupled into the cavity in an advantageous manner.

The microwave oven preferably has an air guide plate for guiding air, which is heated at a heat sink of the microwave generator, into the cavity. The heat sink may preferably be the heat sink of the microwave generator already mentioned further above. This allows additional heating of the interior of the cavity by lost power which is output by the microwave generator.

An air guide plate is preferably in the form of an air diverter which can be operated, so that it can be switched over between a first position, in which it guides the air into the cavity, and a second position, in which it guides the air to the surrounding area. This allows the air to be routed into the cavity only when the air is also actually warmer than the interior of the cavity. Particularly if a cavity is already considerably heated by means of a resistance heater, the process of blowing-in relatively cold air can be prevented in this case.

The air guide plate can be designed, in particular, to guide air to the surrounding area through a front panel. In this way, the front panel can also be cooled or, as is known, the viewing window can be cooled, for example by means of the Venturi effect.

A fan of the microwave generator is preferably designed for the purpose of also cooling further components of the microwave oven. The components may be, in particular, components of a resistance heater or of a controller. A fan or tangential fan for this purpose can, in particular, be saved in this way. This permits a simpler design and therefore a further reduction in costs for the peripheral of the microwave generator in the appliance.

A combination appliance can typically be operated in different modes of operation, for example only with microwave heating, only with resistance heating, be that for forced convection as hot air/circulating air, free convection as heat from the top/heat from the bottom, conduction as hot stone/heated baking sheet, steam generation, radiation or in a combined manner with microwave and resistance heating. A combination with inductive heating is also feasible in principle.

It is intended to be understood that all of the features mentioned in this description or shown in the drawing can also be of independent importance in a manner essential to the invention and the disclosure of this application also includes microwave generators or microwave ovens with in each case only one such feature or with any desired combination of such features. In particular, the division into two channels explained above is not absolutely necessary in order to implement other features which may be essential to the invention.

This and further features are evident not only from the claims but also from the description and from the drawings, it being possible for the individual features to in each case be realized by themselves or as a plurality in the form of subcombinations in an embodiment of the invention and in other fields and to constitute advantageous embodiments which can be protected per se and for which protection is claimed here. The subdivision of the application into individual sections and subheadings does not restrict the generality of the statements made under the latter.

### BRIEF DESCRIPTION OF THE SEVERAL VIEWS OF THE DRAWINGS

Further features and advantages will be gathered by a person skilled in the art from the exemplary embodiments which are described below with reference to the attached drawings, are schematically illustrated in the drawings and will be explained in greater detail in the text which follows. In the drawings:

FIG. 1 shows a microwave generator;

FIG. 2 shows a circuit of a microwave generator;

FIG. 3 shows a microwave oven; and

FIG. 4 shows a schematic view of a phased array antenna.

### DETAILED DESCRIPTION

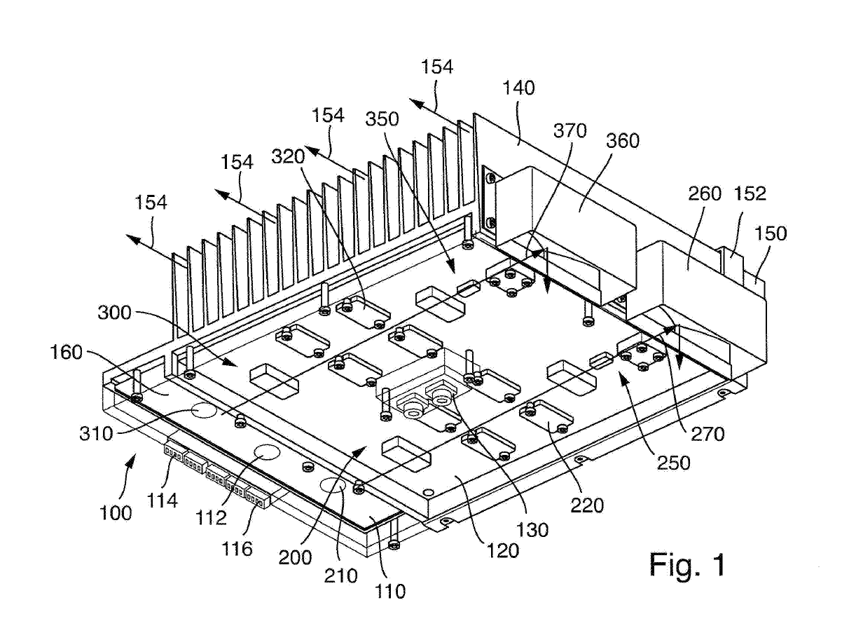

FIG. 1 shows a microwave generator 100 according to an exemplary embodiment of the invention. The microwave generator 100 has a control board 110 on which, amongst other things, a microcontroller 112 for controlling the microwave generator 100 is fitted. The control board 110 further has a first connection 114 and a second connection 116. The first connection 114 serves for communicating with further components of a microwave oven in which the microwave generator 100 is used. The second connection 116 serves as a fan connection which will be discussed in greater detail further below.

The microwave generator 100 has an amplifier board 120 which contains a number of electrical components which will be described in greater detail further below. The microwave generator 100 further has, beneath the amplifier board 120, a connection 130 for supplying voltage to the components of the microwave generator 100 which can be arranged in another position in the appliance.

A heat sink 140 is arranged above the amplifier board 120, the heat sink being attached, without intermediate means, on the amplifier board 120 and being directly connected to the amplifier board. The heat sink serves to discharge heat which is generated by components which are arranged on the amplifier board 120 and will be described in greater detail further below. The microwave generator 100 further has a fan 150 which is fitted to the heat sink 140 by means of a holder 152. The holder 152 is composed of plastic in the present case. The fan 150 is designed for the purpose of generating an air flow 154 through ribs of the heat sink 140 and improving the discharge of heat from the heat sink 140 in this way.

A first channel 200 and a second channel 300 are formed in the microwave generator 100. The channels 200, 300 are in each case provided for generating microwaves, it being possible, in particular, for a product to be cooked to be heated by the microwaves in a cavity, not illustrated in FIG. 1, of a microwave oven, the microwave generator 100 possibly being a constituent part of the microwave oven. The two channels 200, 300 are of identical design and will be described in detail in the text which follows. In the process, the first channel 200 will first be described in detail.

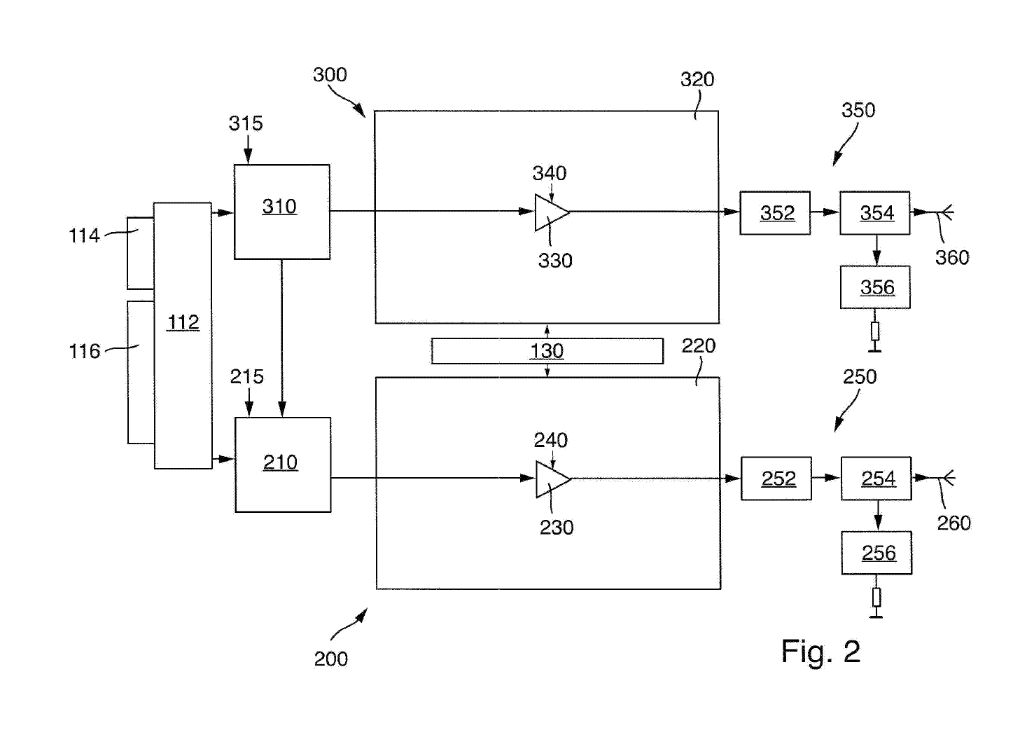

The first channel 200 has a first oscillator 210 which is arranged on the control board 110. Furthermore, the first channel has a first amplifier circuit 220 which is arranged on the amplifier board 120. The first amplifier circuit 220 will be described in more detail further below with reference to FIG. 2. The first channel 200 also has a first power measuring circuit 250 which is designed for the purpose of measuring a power which is output by the first channel 200 and also a reflected power. This will also be discussed in greater detail further below with reference to FIG. 2. Furthermore, the first channel 200 has a first antenna 260 which is designed for the purpose of emitting microwaves. To this end, the first antenna 260 is connected to the first power measuring circuit 250, and the power measuring circuit is in turn connected to the first amplifier circuit 220. Overall, this produces a first path 270 which describes the propagation of electrical signals to the boards 110, 120 in the first channel 200 and the emission of microwaves out of the first antenna 260.

The second channel 300 is of identical construction to the first channel 200. All of the components of the second channel 300 are arranged next to the corresponding components of the first channel 200. Therefore, a second oscillator 310 of the second channel 300 is arranged on the control board 110. A second amplifier circuit 320 of the second channel 300 is arranged on the amplifier board 120. A second power measuring circuit 350 is also arranged on the amplifier board 120. A second antenna 360 of the second channel 300 is arranged next to the first antenna 260 on the heat sink 140. Electrical signals and microwaves describe a second path 370 along the second channel 300 and away from the second antenna 360.

The fan 150 already described further above is connected to the second connection 116 of the control board 110. Therefore, electrical energy is supplied to the fan, and the fan can also be switched on and switched off and the power of the fan can also be regulated by means of the microcontroller 112.

The microwave generator 100 is closed off by a cover 160 at the bottom. The cover 160 is actually produced from diecast aluminum, but is illustrated in a transparent manner in FIG. 1 so that components which are situated behind it are visible. The cover 160 forms, together with the heat sink 140, a housing 140, 160 of the microwave generator 100 which encloses the microwave generator, apart from the antennas 260, 360, such that it is impermeable to microwaves.

The two channels 200, 300 and further components of the microwave generator 100 are explained in greater detail in a circuit diagram in FIG. 2. Typical signal paths are also indicated using arrows in the figure. The microcontroller 112 is connected to the first connection 114 and to the second connection 116 in order to communicate with other components of a microwave oven and in order to supply power to and control the fan 150. The microcontroller 112 is further connected to the first oscillator 210 and to the second oscillator 310. The first oscillator 210 is connected to a first voltage source 215, and the second oscillator 310 is connected to a second voltage source 315. The two first and second voltage sources 215, 315 each supply a voltage of 3.3 V as the input voltage for the oscillators 210, 310 in the present case. The voltage sources can likewise be arranged in the microwave generator, preferably on the control board. The oscillators 210, 310 generate a respective output signal which has a specific frequency and is passed on to the first amplifier circuit 220 and, respectively, to the second amplifier circuit 320. The two oscillators 210, 310 are also electrically connected to one another without intermediate means, so that frequency or phase relationships with respect to one another can be adjusted by means of interchanging information, this being possible on account of the oscillators being electrically connected. For example, the oscillators can be operated at different adjustable frequencies and/or with different adjustable phases. However, the oscillators can also be operated at an identical frequency and/or with an identical phase.

The first amplifier circuit 220 can be constructed, in principle, with elements such as transistors and/or operational amplifiers. In particular, the first amplifier circuit can be of two-stage design. In the present case, the first amplifier circuit is illustrated simply as an operational amplifier 230 which is supplied with power by a third voltage source 240. Accordingly, the second amplifier circuit is illustrated simply as an operational amplifier 330 which is supplied with power by a fourth voltage source 340 in the present case. The third and fourth voltage sources 240, 340 are fed by the voltage supply 130 and each supply a voltage of 28 V in the present case.

The first amplifier circuit 220 amplifies the signal which is supplied by the first oscillator 210 and passes it on to the first power measuring circuit 250. Accordingly, the second amplifier circuit 320 amplifies the signal which is supplied by the second oscillator 310 and passes it on to the second power measuring circuit 350.

The first power measuring circuit 250 has a first output power meter 252, a first circulator 254 and a first reflection power meter 256. The first circulator 254 is, in turn, connected to the first antenna 260. The power which is output by the amplifier circuit 220 can be determined by means of the first output power meter 252. The power is passed via the first circulator 254 to the first antenna 260, and emitted from there. When waves which are reflected by the first antenna 260 are received, the waves are passed on to the first reflection power meter 256 by the circulator 254, and then dissipated in the form of heat in a load resistor. The reflection power meter 256 measures the reflected power, so that a power which was actually left in the product being cooked can be calculated from the difference between the output power and the reflected power. Power measurement for the preceding and following waves can also be performed, in principle, in a combined power measuring unit downstream of the circulator 254.

Accordingly, the second power measuring circuit 350 has a second output power meter 352, a second circulator 354 and a second reflection power meter 356. The second circulator 354 is connected to the second antenna 360. The function of the components of the second channel 300 is identical to those of the first channel which have been described above.

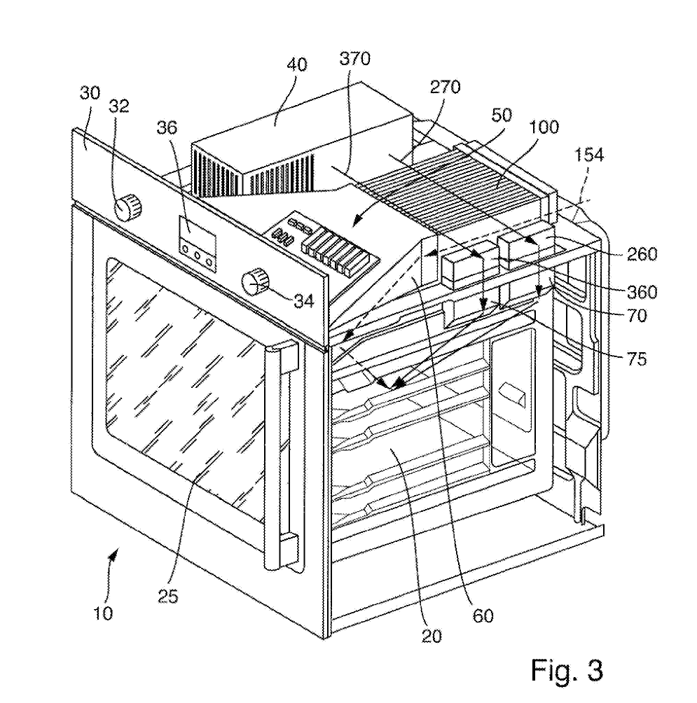

FIG. 3 shows a microwave oven 10 having a microwave generator 100; the microwave oven may possibly also be a so-called combination appliance. The microwave oven 10 is in the form of a combination appliance which means that it can be operated both with microwaves and with a conventional resistance heating system. The microwave oven 10 has a cavity 20 which is accessible via a door 25. The door 25 can be opened and closed for this purpose. A product which is to be cooked and which is intended to be heated by means of the microwave oven 10 can be inserted into the cavity 20. The microwave oven 10 has a front panel 30 having a first rotary controller 32, a second rotary controller 34 and a display 36. A user can make adjustments, in order to operate and to use the microwave oven 10, by means of the rotary controllers 32, 34 and the display 36.

The microwave generator 100 is arranged above the cavity 20. An air guide plate 60, which is in the form of a controllable air diverter, is arranged between the front panel 30 and the microwave generator 100. The air diverter can guide the air flow 154 which is generated by the fan 150 of the microwave generator 100 either into the cavity 20 or through a gap between the door 25 and the front panel 30. Therefore, the air flow 154 can be guided into the cavity 20 when the air flow is warmer than the interior of the cavity 20, in order to assist heating. If, however, the interior of the cavity 20 is already warmer than the air flow 154, the air flow can be guided to the outside, in order to prevent the cavity 20 from being unnecessarily cooled down. Suitable temperature sensors, not illustrated, can be used for the temperature measurement process.

A relay board 50 is arranged on the air guide plate 60, various switches and control system components for the microwave oven 10 being arranged on the relay board. In particular, relays which control a resistance heating system, not illustrated in more detail, of the microwave oven 10 are also arranged on the relay board. By virtue of being arranged on the air guide plate 60, the relay board 50 is likewise cooled by the air flow 154, so that additional cooling components, for example a tangential fan which is otherwise customarily provided, can be dispensed with. The front glass pane can likewise be cooled by the fan in a known manner by way of an air outlet between the front panel 30 and the door 25.

The two antennas 260, 360 of the microwave generator 100 are accommodated in respective waveguides 70, 75 of the cavity 20. This allows the microwaves which are emitted by the antennas 260, 360 to be coupled into the cavity 20, as is also illustrated in FIG. 3 using the two paths 270, 370 which are already shown in FIG. 1. The further away the antennas 260, 360 are from the actual cavity 20 through the waveguides, the more they and therefore the entire microwave generator 100 are decoupled from the influences in the cavity 20. For example, very high temperatures or levels of humidity can occur in the cavity owing to the additional heating systems. Soiling due to the product being cooked spitting is also possible. Therefore, shielding devices are preferably fitted at the connection points between the waveguides and the cavity, the shielding devices allowing microwaves to pass but preventing air from being exchanged. Plastics, glasses, ceramics or mica for example are suitable for this purpose. The shielding devices also prevent dirt entering the waveguides 70, 75 since the waveguides would be difficult to access for cleaning purposes.

A conventional power supply unit 40 which supplies electrical energy to the entire microwave oven 10 or only to the microwave generator 100 is arranged next to the microwave generator 100.

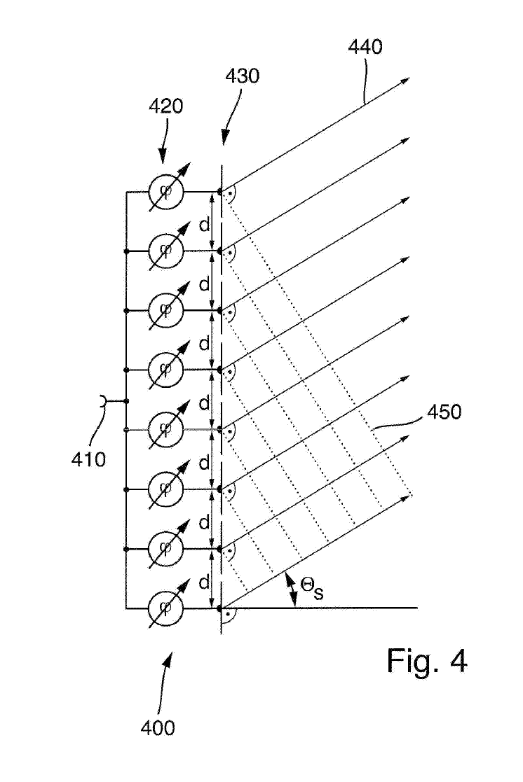

FIG. 4 schematically shows a phased array antenna 400, as can be used, for example, in a microwave oven. The phased array antenna 400 can be used, in particular, in the microwave oven from FIG. 3. The phased array antenna 400 has a signal input 410 to which a channel of a microwave generator can be connected. The signal input 410 is connected to a total of eight phase shifters 420, each of which is, in turn, connected to an antenna 430. The total of eight antennas 430 are arranged in a row at a respective distance which is denoted d. This distance d is identical for each two adjacent antennas 430.

An individual phase shift can be set for each of the antennas 430 by means of the phase shifters 420. In particular, the phases can be distributed in this way, with the phase shift between each two adjacent antennas increasing by a constant amount in one direction. The frequency of the respectively emitted microwaves is identical however.

A propagation direction of emitted waves 440 can be adjusted in a known manner with a phase shift of this kind. The waves 440 are assume an angle of OS in relation to a direction which is transverse to the row of antennas 430. The angle OS can be varied by different phase shifts between in each case two adjacent antennas. Wave fronts 450, of which the angle in relation to the row of antennas 430 is identical to the angle OS, each run transversely to the waves 440.

The described control of the propagation direction of the waves 440 by means of a phase shift can be used, in particular, to irradiate specific regions within a cavity in a targeted manner. In this way, it is possible, for example, to realize a function in which a product being cooked or parts of a product being cooked is/are, for example, identified by means of a camera or by means of evaluation of the microwave reflection behavior at deliberately selected settings. Based on the settings, the product being cooked can be heated in a targeted manner, that is more intensely or else less intensely. It is intended to be understood that any combination of a specific phase shifter with an associated antenna can be called a channel in this case, with all channels being operated at the same frequency here and only the phases differing. Functions of this kind can likewise be used during operation of the channels at different frequencies.

That which is claimed:

1. A microwave generator for a microwave oven, wherein:
said microwave generator comprises at least one first channel and one second channel;
said first channel has a first amplifier circuit and a first antenna being connected to said first amplifier circuit, for generating microwaves with a power of up to a maximum of a first partial power;
said second channel comprises a second amplifier circuit and a second antenna being connected to said second amplifier circuit, for generating microwaves with a power of up to a maximum of a second partial power; and
a maximum total power of said microwave generator is made up of said partial powers of said channels of said microwave generator.

2. The microwave generator as claimed in claim 1, wherein:
a number of further said channels is provided; and
each further said channel has a respective said amplifier circuit and a respective said antenna, which is connected to said respective amplifier circuit, for generating said microwaves with a power of up to a maximum of a respective said partial power.

3. The microwave generator as claimed in claim 1, wherein said amplifier circuits each have a number of transistors for generating or amplifying a current which operates said respective antenna.

4. The microwave generator as claimed in claim 1, wherein said amplifier circuits are arranged on a common amplifier board.

5. The microwave generator as claimed in claim 4, wherein said amplifier board is mounted, without intermediate means, on a heat sink of said microwave generator.

6. The microwave generator as claimed in claim 5, wherein said amplifier board is mounted, without intermediate means, on a flat bottom face of said heat sink.

7. The microwave generator as claimed in claim 5, wherein a fan is associated with said heat sink.

8. The microwave generator as claimed in claim 7, wherein electrical power is supplied to said fan by a control board being connected to said amplifier board.

9. The microwave generator as claimed in claim 4, wherein a control board, further boards, said antennas, fans or further components are mounted on said heat sink.

10. The microwave generator as claimed in claim 9, wherein said boards or antennas are screwed directly to said heat sink.

11. The microwave generator as claimed in claim 10, wherein said fans are fastened to said heat sink by means of a respective holder.

12. The microwave generator as claimed in claim 4, wherein said antennas are fitted, without intermediate means, to one end of said heat sink.

13. The microwave generator as claimed in claim 12, wherein said antennas are fitted, without intermediate means, directly or without a flange plate to one end of said heat sink.

14. The microwave generator as claimed in claim 4, wherein said antennas are directly wired to said respective amplifier circuits.

15. The microwave generator as claimed in claim 14, wherein said antennas are directly wired to said respective amplifier circuits without an interconnection of coaxial plugs or coaxial cables.

16. The microwave generator as claimed in claim 1, wherein said microwave generator is designed for a purpose of operating said channels at different frequencies or with different phases.

17. The microwave generator as claimed in claim 16, wherein said antennas together form a phased array antenna.

18. The microwave generator as claimed in claim 17, wherein said microwave generator is designed for a purpose of setting a propagation direction of microwaves being emitted by said phased array antenna, by means of phase relationships of said channels with respect to one another.

19. The microwave generator as claimed in claim 1, wherein said microwave generator comprises a cover, which closes off said microwave generator such that said microwave generator is impermeable to microwaves at least on one side.

20. The microwave generator as claimed in claim 19, wherein said cover closes off said microwave generator at a bottom.

21. The microwave generator as claimed in claim 19, wherein said cover, together with a heat sink, forms a housing of said microwave generator.

22. A microwave oven, comprising:
a cavity; and
a microwave generator, wherein:
said microwave generator comprises at least one first channel and one second channel;
said first channel comprises a first amplifier circuit and a first antenna being connected to said first amplifier circuit, for generating microwaves with a power of up to a maximum of a first partial power;
said second channel comprises a second amplifier circuit and a second antenna being connected to said second amplifier circuit, for generating microwaves with a power of up to a maximum of a second partial power,
and with a maximum total power of said microwave generator being made up of said partial powers of said channels of said microwave generator; and
the microwave generator is designed and arranged in said microwave oven for a purpose of emitting microwaves into said cavity.

23. The microwave oven as claimed in claim 22, wherein the microwave oven comprises an air guide plate for guiding air, which is heated at a heat sink of said microwave generator, into said cavity.

24. The microwave oven as claimed in claim 23, wherein said air guide plate is in the form of an air diverter which can be operated, so that said air guide plate is switchable over between a first position, in which said air guide plate guides said air into said cavity, and a second position, in which said air guide plate guides said air to a surrounding area.

25. The microwave oven as claimed in claim 22, wherein a fan of said microwave generator is designed for a purpose of also cooling a controller of said microwave oven.
